(19) United States
(12) Patent Application Publication
(10) Pub. No.: US 2024/0251829 A1
(43) Pub. Date: Aug. 1, 2024

(54) COMPOSITIONS

(71) Applicant: GIVAUDAN SA, VERNIER (CH)

(72) Inventors: Mariaelena Zuniga HAYES, Cincinnati, OH (US); Melissa ASSAD BUSTILLOS, Kemptthal (CH)

(21) Appl. No.: 18/633,492

(22) Filed: Apr. 11, 2024

Related U.S. Application Data
(63) Continuation-in-part of application No. PCT/EP2022/078133, filed on Oct. 10, 2022.
(60) Provisional application No. 63/254,750, filed on Oct. 12, 2021.

(51) Int. Cl. A23L 7/10; A23L 2/39; A23L 2/56; A23L 19/00; A23L 27/00; A23L 27/10

(52) U.S. Cl. CPC A23L 7/115; A23L 2/39; A23L 2/56; A23L 19/01; A23L 27/10; A23L 27/88

(57) ABSTRACT

A composition including plant-derived carbohydrate fiber that is not a beta-glucan fiber and a beta-glucan fiber as mouthfeel-improving additives for a consumable is disclosed. A consumable containing the composition of the plant-derived non-beta-glucan carbohydrate fiber and beta-glucan fiber as mouthfeel-improving additives, and methods for preparing a consumable including the mouthfeel-improving composition and for improving the mouthfeel of a consumable by adding the mouthfeel-improving composition to a consumable base are also disclosed.

### TECHNICAL FIELD

The present disclosure relates to a composition for improving the mouthfeel of a consumable, a consumable including the composition, a method for preparing a consumable including the composition, and a method for improving the mouthfeel of a consumable by adding the mouthfeel-improving composition to a consumable base. The present disclosure more particularly relates to a composition for improving the mouthfeel of a consumable snack food or beverage, a snack food or beverage including the composition, a method for preparing a snack food or beverage including the composition, and a method for improving the mouthfeel of a snack food or beverage by adding the mouthfeel-improving composition to a snack food or beverage base.

### BACKGROUND

Dry beverage compositions and powdered beverage mixes are powdered mixes that are reconstituted with a drinkable liquid, such as water, to provide a ready-to-drink beverage. Such powdered mixes are typically formulated to achieve desired mouthfeel, color, flavor, and nutritional characteristics when the dry mix is reconstituted with the drinkable liquid.

Powdered beverage mixes are typically thickened with gums, such as xanthan gum, guar gum, pectin, or the like to provide a desired target mouthfeel. However, the use of such gums to thicken the beverages often results in an undesired “gummy” mouthfeel of the reconstituted beverage.

Snack foods are items of food that are typically prepared by cooking a batter or dough. Snack foods can be shaped in various forms and presented in a consumer acceptable retail format, for example a packaging such as a bag or carton, typically hermetically sealed, which is compatible with a retail sales environment. However, in whatever form a snack food is presented, its mouthfeel will determine the overall sensory experience and satisfaction of consumers.

It is therefore desirable in the art to provide a consumable, such as a powdered beverage mix or snack food that includes additives, which when the dry powder mix is reconstituted with a drinkable liquid, or when the snack food contains said additives, results in a consumable product with a more suitable mouthfeel and texture.

### SUMMARY

Disclosed is a composition comprising at least one carbohydrate fiber that is not a beta-glucan and at least one beta-glucan fiber.

According to certain illustrative embodiments, the composition comprises at least one plant-derived carbohydrate fiber that is not a beta-glucan and at least one plant-derived beta-glucan fiber.

According to certain illustrative embodiments, disclosed is a composition consisting essentially of at least one plant-derived carbohydrate fiber that is not a beta-glucan and at least one plant-derived beta-glucan fiber.

According to certain illustrative embodiments, disclosed is a composition consisting of at least one plant-derived carbohydrate fiber that is not a beta-glucan and at least one plant-derived beta-glucan fiber.

According to further illustrative embodiments, disclosed is a consumable comprising a consumable base, at least one plant-derived carbohydrate fiber that is not a beta-glucan, and at least one plant-derived beta-glucan fiber.

According to further illustrative embodiments, disclosed is a beverage comprising a beverage base, at least one plant-derived carbohydrate fiber that is not a beta-glucan and at least one plant-derived beta-glucan fiber.

According to further illustrative embodiments, disclosed is a ready-to-drink beverage comprising a beverage base, at least one plant-derived carbohydrate fiber that is not a beta-glucan and at least one plant-derived beta-glucan fiber.

According to further illustrative embodiments, disclosed is a powdered beverage composition comprising a beverage base, at least one plant-derived carbohydrate fiber that is not a beta-glucan and at least one plant-derived beta-glucan fiber.

According to further illustrative embodiments, disclosed is a snack food composition comprising a snack food base, and a mouthfeel-improving composition comprising at least one plant-derived carbohydrate fiber that is not a beta-glucan and at least one plant-derived beta-glucan fiber.

According to further illustrative embodiments, disclosed is a method for preparing a consumable comprising adding to a consumable base at least one plant-derived carbohydrate fiber that is not a beta-glucan and at least one plant-derived beta-glucan fiber.

According to further illustrative embodiments, disclosed is a method of improving the mouthfeel of a consumable comprising adding mouthfeel-improving amounts of at least one plant-derived carbohydrate fiber that is not a beta-glucan and at least one plant-derived beta-glucan fiber to a consumable base.

According to further illustrative embodiments, disclosed is the use of a combination of at least one plant-derived carbohydrate fiber that is not a beta-glucan and at least one plant-derived beta-glucan fiber to improve the mouthfeel of a consumable.

### BRIEF DESCRIPTION OF THE DRAWINGS

The patent or application file contains at least one color drawing. Copies of this patent or patent application publication with color drawing(s) will be provided by the Office upon request and payment of the necessary fee.

FIG. 1 shows the measured hardness (maximum force/g) reach during compression of each Sample.

FIGS. 2A and 2B show a cross-section of Samples 1 and 3 obtained from x-ray tomography showing internal cellular structure.

FIGS. 3A and 3B show quantitative analysis of porosity of Samples 1 and 3 across various cross sections.

FIGS. 4A and 4B show pore size distribution of different 3D cross sections for Samples 1 and 3.

### DETAILED DESCRIPTION

The following text sets forth a broad description of numerous different embodiments of the present disclosure. The description is to be construed as exemplary only and does not describe every possible embodiment since describing every possible embodiment would be impractical, if not impossible. It will be understood that any feature, characteristic, component, composition, ingredient, product, step or methodology described herein can be deleted, combined with or substituted for, in whole or part, any other feature, characteristic, component, composition, ingredient, product, step or methodology described herein. Numerous alternative embodiments could be implemented, using either current technology or technology developed after the filing date of this patent, which would still fall within the scope of the claims.

Disclosed is a composition comprising non-beta glucan carbohydrate fibers and beta-glucan fibers. According to certain embodiments, the composition comprises at least one plant-derived non-beta-glucan carbohydrate fiber and at least one plant-derived beta-glucan fiber.

According to certain illustrative embodiments, the non-beta-glucan carbohydrate fibers and the beta-glucan fibers may be separately added as individual components to a dry powder beverage base formulation or to a snack food base in mouthfeel-improving amounts of these additives. According to other embodiments, the non-beta-glucan carbohydrate fibers and beta-glucan fibers may be formulated into a composition comprising both mouthfeel improving additives, and the composition added to a dry powder beverage base formulation or to a snack food base. The composition comprising the at least one non-beta-glucan carbohydrate fiber and the at least one beta-glucan fiber is formulated to be incorporated into a dry powder beverage mix to be reconstituted with a drinkable liquid, such as water, to provide a ready-to-drink beverage, or to be incorporated into a snack food base. The mouthfeel-improving additives of the at least one non-beta-glucan carbohydrate fiber and the at least one beta-glucan fiber are present in the composition or a consumable in mouthfeel-improving amounts to improve the mouthfeel of the reconstituted beverage. According to certain illustrative embodiments, the mouthfeel-improving additives of the at least one plant-derived non-beta-glucan carbohydrate fiber and the at least one beta-glucan fiber are present in a dry powder beverage mix in mouthfeel-improving amounts to improve the mouthfeel of the resulting beverage after the dry powder beverage mix has been reconstituted with a drinkable liquid. According to certain other illustrative embodiments the mouthfeel-improving composition of the at least one plant-derived non-beta-glucan carbohydrate fiber and the at least one beta-glucan fiber are present in a snack food base in mouthfeel-improving amounts to improve the mouthfeel of the resulting snack food. The term “improved mouthfeel” means that i) a ready-to-drink beverage prepared from a dry powder beverage mix formulation with the addition of the mouthfeel-improving additives of the at least one plant-derived non-beta-glucan carbohydrate fiber and the at least one beta-glucan fiber reconstituted with a drinkable liquid, or ii) a snack food prepared from a snack food base with the addition of the mouthfeel-improving additives of the at least one plant-derived non-beta-glucan carbohydrate fiber and the at least one beta-glucan fiber, has an improved mouthfeel and texture as compared to a reconstituted beverage or a snack food prepared from the same dry powder beverage mix formulation or snack food base but without the addition of the mouthfeel-improving additives of the at least one plant-derived non-beta-glucan carbohydrate fiber and the at least one beta-glucan fiber. According to certain illustrative embodiments, the at least one plant-derived non-beta-glucan carbohydrate fiber and the at least one beta-glucan fiber are present in the dry powder beverage mix or in the snack food in mouthfeel-improving amounts to improve the mouthfeel of such, such that the mouthfeel of the reconstituted beverage approximates or imitates the mouthfeel of a dairy yogurt drink or dairy yogurt smoothie, or the snack food has a requisite mouthfeel to provide a desirable sensory experience

According to certain embodiments, the consumable containing the plant-derived non-beta-glucan carbohydrate fiber and beta-glucan fiber is a product that can be considered to be a “clean-label” product. The “clean-label” movement is a consumer movement or trend driven by health and nutrition conscious consumers. The term “clean-label” is a term that has been adopted by the food industry, consumers, academics, and governmental regulatory agencies. A “clean-label” product is a food product that contains as few ingredients as possible, and which are generally recognized as natural, familiar, and simple ingredients. Consumers and the general public consider, perceive, or recognize the ingredients in the “clean-label” product as being healthy or wholesome, and not artificial, processed, synthetic, or to contain chemicals.

Without limitation, and only by way of illustration, the at least one plant-derived non-beta-glucan carbohydrate fiber may be derived from algae, beans, broccoli, mycoprotein, nuts, peas, potatoes, oatmeal, seeds, plant leaf protein, cereal (such as, without limitation, corn), seitan, tempeh, tofu, fruits (such as, without limitation, citrus, banana) chicory root, inulin and mixtures thereof.

According to certain illustrative embodiments, the at least one plant-derived non-beta-glucan carbohydrate fiber is derived from peas. Without limitation, the peas may be selected from black eyed peas, chickpeas, green peas and mixtures thereof.

According to certain illustrative embodiments, the at least one plant-derived non-beta-glucan carbohydrate fiber is derived from fruits. Without limitation, the fruits may be selected from one or more of citrus, banana, apple, pineapple, peach, strawberry, figs, kiwis, and the like.

Without limitation, the citrus may preferably be selected from orange, bitter orange, lemon, mandarin and mixtures thereof.

According to certain illustrative embodiments, the at least one plant-derived non-beta-glucan carbohydrate fiber may be derived from beans selected from black beans, canelli beans, kidney beans, lentil beans, lima beans, pinto beans, soy beans, white beans, mung beans and mixtures thereof.

According to certain illustrative embodiments, the at least one plant-derived non-beta-glucan carbohydrate fiber may be derived from nuts selected from almonds, brazil nuts, cashews, peanuts, pecans, hazelnuts, pine nuts, walnuts and mixtures thereof.

According to certain illustrative embodiments, the at least one plant-derived non-beta-glucan carbohydrate fibers may be derived from plant seeds selected from chia, flax, hemp, pumpkin, sesame, sunflower and mixtures thereof.

According to certain illustrative embodiments, the at least one plant-derived non-beta-glucan carbohydrate fibers may be derived from cereal selected from oatmeal, wheat, barley, spelt, corn, rice and mixtures thereof.

According to certain illustrative embodiments the at least one plant-derived non-beta-glucan carbohydrate fiber may be a water soluble fiber, a water dispersible fiber, a water insoluble fiber or mixtures thereof.

According to certain illustrative embodiments the at least one plant-derived non-beta-glucan carbohydrate fiber may be water soluble, including but limited to soluble corn dextrin, pea soluble dextrin, chicory root soluble fructan.

According to certain illustrative embodiments the at least one plant-derived non-beta-glucan carbohydrate fiber may be water insoluble including but limited to banana fibers.

According to certain illustrative embodiments the at least one plant-derived non-beta-glucan carbohydrate fiber may be water dispersible, including but limited to citrus fibers.

According to certain illustrative embodiments, the at least one beta-glucan fiber is selected from bacteria-derived beta-glucan, grain-derived beta-glucan, fungi-derived beta-glucan, yeast-derived beta-glucan, and combinations thereof. According to certain illustrative embodiments, the at least one beta-glucan fiber is selected from barley, shiitake, reishi mushrooms, seaweed, algae, wheat, oat and rye and combinations thereof.

According to certain illustrative embodiments, the at least one plant-derived non-beta-glucan carbohydrate fiber is derived from peas and the at least one beta-glucan fiber is a grain-derived beta-glucan fiber. According to certain embodiments, the at least one plant-derived non-beta-glucan carbohydrate fiber is derived from peas and the at least one beta-glucan fiber is an oat-derived beta-glucan. According to certain embodiments, the at least one plant-derived non-beta-glucan carbohydrate fiber is derived from peas and is present in a composition or dry powder beverage mix in the form of fibers and the at least one beta-glucan fiber is an oat-derived beta-glucan fibers and is present in the composition or dry powder beverage mix in the form of soluble fibers.

The amounts of the at least one plant-derived non-beta-glucan carbohydrate fiber and at least one beta-glucan fiber may be included in a consumable base at a ratio of the plant-derived non-beta-glucan carbohydrate fiber to the beta-glucan fiber in the range from about 10:90 to about 90:10, or from about 20:80 to about 80:20, or from about 30:70 to about 70:30, or from about 40:60 to about 60:40, or from about 45:55 to about 55:45, or at any ratio from about 10:90 to about 90:10. According to certain illustrative embodiments, the ratio of the plant-derived non-beta-glucan carbohydrate fiber to the beta-glucan fiber included in the consumable is from about 40:60 to about 60:40. According to other illustrative embodiments, the ratio of the plant-derived non-beta-glucan carbohydrate fiber to the beta-glucan fiber included in the consumable base is about 50:50.

The composition or consumable may include at least one fat. The fat may be selected from animal-derived fats and plant-derived fats. Suitable animal fats include animal-derived butter fats, milk fats, lard, and the like. Without limitation, for example, the animalic fat may be derived from chicken, cow, duck, goose, pig and combinations thereof.

According to certain embodiments, fat component of the composition may comprise an oil selected from algal oils, insect oils, vegetable-derived oils and combinations. According to certain embodiments, the fat component comprises one or more vegetable-derived oils. Without limitation, and only by way of illustration, suitable vegetable oils include almond oil, avocado oil, canola oil, coconut oil, corn oil, cottonseed oil, flaxseed oil, hazelnut oil, illipe oil, linseed oil, palm oil, palm kernel oil, peanut oil, pecan oil, pumpkin seed oil, oat oil, olive oil, rapeseed oil, safflower oil, sesame oil, shea oil, soybean oil, sunflower oil, walnut oil, and mixtures thereof.

According to certain illustrative embodiments, the composition and consumable may further include at least one probiotic, at least one prebiotic, or a combination thereof. The phrase “at least one probiotic” means that the composition or consumable includes one or more than one probiotic. The phrase “at least one prebiotic” means that the composition or consumable includes one prebiotic or more than one prebiotic. According to certain illustrative embodiments, the composition or consumable may include one probiotic and more than one prebiotic. According to other illustrative embodiments, the composition or consumable may include more than one probiotic and one prebiotic. According to certain illustrative embodiments, the composition or consumable may contain one probiotic and one prebiotic. According to certain illustrative embodiments, the composition or consumable may contain more than one probiotic and more than one prebiotic. The at least one probiotic, at least one prebiotic, or combination thereof is present in the composition or consumable in an amount effective to confer or promote health benefit on a subject.

According to certain illustrative embodiments, probiotics comprise live microorganisms that confer or otherwise impart a health benefit to a subject when consumed in an effective amount. Without limitation, and only by way of illustration, suitable probiotics are selected from bacteria, yeasts, and fungi. Without being bound to any particular theory, it is believed that probiotics improve or restore a subject's naturally-occurring gastrointestinal microflora and impart health benefits apart from nutrition.

Suitable probiotics include, but are not limited to, bacteria of the genus Lactobacillus, Bifidobacteria, Streptococcus, or combinations thereof.

According to certain illustrative embodiments, the at least one probiotic may be selected from the genus Lactobacillus. Suitable non-limiting examples of Lactobacillus species found in the human intestinal tract include L. acidophilus, L. casei, L. fermentum, L. saliva roes, L brevis, L. leichmannii, L. plantarum, L. cellobiosus, L. reweri, L. rhamnosus, L. hulgaricus, and L. thermophilus.

According to certain illustrative embodiments, the at least one probiotic may be selected from the genus Bifidobacteria. Suitable non-limiting species of the genus Bifidobacteria found in the human gastrointestinal tract include B. angulatum, B. animalis, B. asteroides, B. bifdum, B. bourm, B. breve, B. catenulatum, B. choerinum. B. cogneforme, B. cuniculi, B. dentiumn, B. gallicum, B. gallinarum, B indicum, B. longwn, B. magnum, B. merycicum, B. minimum, B. pseudocatenu/atum, B. pseudolongwn, B. psychraerophilum, B. pullorum, B. ruminantium, B. saeculare, B. scardovil, B. simiae, B. subtile, B. thermacidophilum, B. thermophilum, and B. urinahs.

Prebiotics promote the growth of beneficial bacteria in the intestines. Prebiotic substances can be consumed by a relevant probiotic, or otherwise assist in keeping the relevant probiotic alive or stimulate its growth. When consumed in an effective amount, prebiotics also beneficially affect the human body's naturally-occurring gastrointestinal microflora and thereby impart health benefits apart from just nutrition. Prebiotic foods enter the colon and serve as substrate for the endogenous bacteria, thereby indirectly providing the host with energy, metabolic substrates, and essential micronutrients.

Without limitation, and only by way of illustration, prebiotics may be selected from mucopolysaccharides, oligosaccharides, polysaccharides, amino acids, vitamins, nutrient precursors, proteins and combinations thereof. According to certain illustrative embodiments, the prebiotic may be selected from dietary fibers. According to further illustrative embodiments, the dietary fibers may be selected from polysaccharides and oligosaccharides. Without limitation, and only by way of illustration, suitable oligosaccharides that are categorized as prebiotics include fructooligosaccharides, inulins, isomalto-oligosaccharides, lactilol, lactosucrose, lactulose, dextrins, soy oligosaccharides, transgalacto-oligosaccharides, and xylo-oligosaccharides. Prebiotics may be obtained from foods such as bananas, berries, asparagus, garlic, wheat, oats, flaxseed, tomatoes, Jerusalem artichoke, onions and chicory, greens (e.g., dandelion greens, spinach, collard greens, chard, kale, mustard greens, turnip greens), and legumes (e.g., lentils, kidney beans, chickpeas, navy beans, white beans, black beans).

The composition may further include at least one sweetener in a sweetening-effective amount to impart a desired sweetness to the composition and the resulting consumable to which the composition is added. The at least one sweetener may comprise at least one caloric sweetener, or at least one non-caloric sweetener, or a combination of at least one caloric sweetener and at least one non-caloric sweeteners. The non-caloric sweeteners may be selected from synthetic non-caloric sweeteners and natural non-caloric sweeteners.

Without limitation, and only by way of illustration, suitable synthetic non-caloric sweeteners include acesulfame K, advantame, aspartame, cyclamate, neotame, neohesperidin dihydrochalcone, saccharin, sucrolose and combinations thereof.

Without limitation, and only by way of illustration, suitable non-caloric natural sweeteners include steviol glycosides selected from stevioside, rebaudioside A, rebaudioside B, rebaudioside C, rebaudioside D, rebaudioside E, rebaudioside F, rebaudioside G, rebaudioside H, rebaudioside I, rebaudioside J, rebaudioside K, rebaudioside L, rebaudioside M, rebaudioside N, rebaudioside O, dulcoside A, dulcoside B, rubusoside, and combinations thereof, mogrol glycosides selected from mogroside I, mogroside II, mogroside III, mogroside IV, mogroside V, isomogroside V, 11-oxomogroside, siamenoside I and combinations thereof, Luo Han Guo sweetener, Swingle Extract, erythritol, glycyrrhizic acid, thaumatin, brazzein, monatin and combinations thereof.

Without limitation, and only by way of illustration, suitable caloric sweeteners include sucrose, fructose, glucose, high fructose corn syrup, corn syrup, xylose, arabinose, rhamnose, erythritol, xylitol, mannitol, sorbitol, inositol, allulose and combinations thereof.

The mouthfeel-improving composition may further include nutritionally effective amounts of at least one vitamin, or at least one mineral or a combination of at least one vitamin and at least one mineral. According to certain embodiments, the composition comprises a nutritionally effective amount of at least one vitamin. According to certain embodiments, the composition comprises a nutritionally effective amount of more than one different vitamin. According to certain embodiments, the composition comprises a nutritionally effective amount of at least one mineral. According to certain embodiments, the composition comprises a nutritionally effective amount of more than one different mineral. According to certain embodiments, the composition comprises a nutritionally effective amount of at least one vitamin and at least one mineral. According to certain embodiments, the composition comprises a nutritionally effective amount of more than one different vitamin and at least one mineral. According to certain embodiments, the composition comprises a nutritionally effective amount of at least one vitamin and more than one different mineral. According to certain embodiments, the composition comprises a nutritionally effective amount of more than one different vitamin and more than one different mineral.

The consumable composition comprises a consumable base, at least one plant-derived non-beta-glucan carbohydrate fiber, and at least one beta-glucan fiber. The consumable may comprise a liquid beverage or a snack food.

The terms “beverage”, “beverage composition” and “beverage product” are used interchangeably herein to mean ready-to-drink beverages, beverage concentrates, beverage syrups, or powdered beverages.

According to illustrative embodiments, the beverage comprises a ready-to-drink beverage. The term “ready-to-drink” beverage as used herein means a beverage in liquid form ready to be consumed without further addition of liquid. The ready-to-drink beverage may comprise any other suitable ingredients known in the art for producing a beverage, such aa, for example, sweeteners (natural or artificial sweeteners); aromas and flavors; milk and/or milk derivatives; acidifiers; stabilizers; natural colors; or any combination thereof. Ready-to-drink beverages are packaged beverages that are sold in a prepared form and are ready for consumption. According to other embodiments, the ready-to-drink beverage may comprise a dry concentrate (for examples powders or granulates) which are indented to be dissolved in water before consumption.

Without limitation, suitable ready-to-drink beverages include carbonated and non-carbonated beverages. Carbonated beverages include, but are not limited to, frozen carbonated beverages, enhanced sparkling beverages, cola, fruit-flavored sparkling beverages (e.g., lemon-lime, orange, grape, strawberry and pineapple), ginger-ale, soft drinks and root beer. Non-carbonated beverages include, but are not limited to, fruit juice, fruit-flavored juice, juice drinks, nectars, vegetable juice, vegetable-flavored juice, sports drinks, energy drinks, enhanced water drinks, enhanced water with vitamins, near water drinks (e.g., water with natural or synthetic flavorants), coconut water, tea type drinks (e.g., black tea, green tea, red tea, oolong tea), coffee, cocoa drink, dairy beverage, beverages comprising milk components (e.g., milk beverages, coffee comprising milk components, cafe au lait, milk tea, fruit milk beverages), beverages comprising cereal extracts, yogurt drinks and smoothies.

According to certain embodiments, the ready-to-drink beverage is a dairy beverage. Dairy beverages, dairy-derived beverages and dairy-alternative products include, but are not limited to, milk, fluid milk, cultured milk product, cultured and noncultured dairy-based drinks, cultured milk product cultured with lactobacillus, yoghurt-based beverage, lassi, milk shake, acidified milk, acidified milk beverage, soy milk, rice milk, rice milk drink, fresh/pasteurized milk, full fat fresh/pasteurized milk, semi skimmed fresh/pasteurized milk, long-life/uht milk, full fat long life/uht milk, semi skimmed long life/uht milk, fat-free long life/uht milk, goat milk, condensed/evaporated milk, plain condensed/evaporated milk, flavoured milk drinks, dairy only flavoured milk drinks, soy milk, sour milk drinks, fermented dairy drinks, coffee whiteners, powder milk, flavoured powder milk drinks, drinking yoghurt, regular probiotic drinking yoghurt. The term “milk” includes, but is not limited to, whole milk, skim milk, condensed milk, evaporated milk, reduced fat milk, low fat milk, nonfat milk, and milk solids (which may be fat or nonfat). According to certain embodiments, the dairy beverage is a yogurt beverage, such as, for example, a yogurt smoothie.

Additionally disclosed is a method for preparing a consumable. The method for preparing the consumable comprises adding to a consumable base at least one plant-derived non-beta-glucan carbohydrate fiber and at least one beta-glucan fiber. The at least one non-beta-glucan carbohydrate fiber and at least one beta-glucan fiber are added to the consumable base in amounts to improve the mouthfeel of the consumable.

Further disclosed is a method of improving the mouthfeel of a consumable comprising. The method comprises adding sufficient amounts of at least one plant-derived non-beta-glucan carbohydrate fiber and beta-glucan fiber to a consumable base to improve the mouthfeel of the consumable.

Mouthfeel (or “mouth feel”) refers to the physical sensations experienced or felt in the mouth that are created by food and beverages, or compositions added to food or beverages. Mouthfeel may refer to textures that come into contact with the tongue, roof of the mouth, teeth, gums, or throat. Mouthfeel is considered to be distinct from taste/flavor, but is considered to have an equal or even greater impact on a person's enjoyment or preference for certain foods over others. Typical mouthfeel descriptors used to describe perceived sensations include acidity (metallic, citrusy, bright), density (close, airy), dryness (arid, scorched), graininess (particulate, powdery, dusty, grainy, chalky), gumminess (chewy, tough), hardness (crunchy, soft), heaviness (full, weighty), irritation (prickly, stinging), mouth coating (oily, buttery), roughness (abrasive, textured), slipperiness (slimy, stringy), smoothness (satiny, velvety), uniformity (even, uneven) and viscosity (full-bodied, light-bodied).

Particularly preferred embodiments are:
1. A composition comprising at least one plant-derived non-beta-glucan carbohydrate fiber and at least one beta-glucan fiber.
2. A composition comprising at least one plant-derived non-beta-glucan carbohydrate fiber and at least one beta-glucan fiber as mouthfeel-improving additives.
3. The composition of embodiment 1, wherein the at least one plant-derived non-beta-glucan fiber is selected from the group consisting of water soluble fiber, water dispersible fiber, water insoluble fiber, and mixtures thereof.
4. The composition of embodiment 3, wherein the water soluble fiber is selected from the group consisting of corn dextrin, pea soluble dextrin, chicory root soluble fructan, and mixtures thereof.
5. The composition of embodiment 1, wherein the at least one plant-derived non-beta-glucan fiber comprises water dispersible fiber.
6. The composition of embodiment 1, wherein the at least one plant-derived non-beta-glucan fiber comprises water insoluble fiber.
7. The composition of embodiment 1, wherein said plant-derived non-beta-glucan carbohydrate fiber is derived from algae, beans, broccoli, mycoprotein, nuts, peas, potatoes, oatmeal, seeds, plant leaf protein, cereal, seitan, tempeh, tofu, fruits, chicory root, inulin and mixtures thereof.
8. The composition of embodiment 7, wherein said plant-derived non-beta-glucan carbohydrate fiber is derived from peas.
9. The composition of embodiment 8, wherein said peas are selected from the group consisting of black eyed peas, chickpeas, green peas and mixtures thereof.
10. The composition of embodiment 7, wherein said plant-derived non-beta-glucan carbohydrate fiber is derived from beans selected from the group consisting of black beans, canelli beans, kidney beans, lentil beans, lima beans, pinto beans, soy beans, white beans, mung beans and mixtures thereof.
11 The composition of embodiment 7, wherein said plant-derived non-beta-glucan carbohydrate fiber is derived from nuts selected from the group consisting of almonds, brazil nuts, cashews, peanuts, pecans, hazelnuts, pine nuts, walnuts and mixtures thereof.
12. The composition of embodiment 7, wherein said plant-derived non-beta-glucan carbohydrate fiber is derived from plant seeds selected from the group consisting of chia, flax, hemp, pumpkin, sesame, sunflower and mixtures thereof.
13. The composition of embodiment 7, wherein said plant-derived non-beta-glucan carbohydrate fiber is derived from cereal selected from the group consisting of oatmeal, corn, wheat, barley, spelt, corn, rice and mixtures thereof.
14. The composition of embodiment 7, wherein said plant-derived non-beta-glucan carbohydrate fiber is selected from fruits selected from the group consisting of apple, banana, citrus, figs, kiwi, peach, pineapple, strawberry, and mixtures thereof.
15. The composition of embodiment 14, wherein the citrus is selected from orange, bitter orange, lemon, mandarin, and mixtures thereof.
16. The composition of embodiment 1, wherein said beta-glucan fiber is selected from bacteria-derived beta-glucan, grain-derived beta-glucan, fungi-derived beta-glucan, yeast-derived beta-glucan, and combinations thereof.
17 The composition of embodiment 16, wherein said beta-glucan fiber is a grain-derived beta-glucan.
18. The composition of embodiment 17, wherein said grain-derived beta-glucan is derived from oat.
19. The composition of embodiment 1, wherein the at least one beta-glucan fiber is derived from barley, shiitake mushroom, reishi mushroom, seaweed, algae, oat, wheat, rye and mixtures thereof.
20. The composition of embodiment 1, wherein the ratio of the plant-derived non-beta-glucan carbohydrate fiber to the beta-glucan fiber is in the range from about 10:90 to about 90:10, or from about 20:80 to about 80:20, or from about 30:70 to about 70:30, or from about 40:60 to about 60:40, or from about 45:55 to about 55:45.
21. The composition of embodiment 20, wherein the ratio of the plant-derived non-beta-glucan carbohydrate fiber to the beta-glucan fiber is from about 40:60 to about 60:40.
22. The composition of embodiment 21, wherein the ratio of the plant-derived non-beta-glucan carbohydrate fiber to the beta-glucan fiber is about 50:50.
23. The composition of embodiment 1, wherein the composition is in powdered form.
24. A consumable comprising a consumable base, plant-derived non-beta-glucan carbohydrate fiber, and beta-glucan fiber.
25. The consumable of embodiment 24, wherein the consumable comprises a beverage.
26. The consumable of embodiment 25, wherein the beverage comprises a ready-to-drink beverage.
27. The consumable of embodiment 26, wherein said ready-to-drink beverage is a dairy beverage.
28 The consumable of embodiment 27, wherein the dairy beverage is a yogurt beverage.
29. The consumable of embodiment 28, wherein the yogurt beverage is a yogurt smoothie.
30. The consumable of embodiment 24, wherein the consumable is a snack food.
31. A method for preparing a consumable comprising adding to a consumable base at least one plant-derived non-beta-glucan carbohydrate fiber and at least one beta-glucan fiber.
32. A method of improving the mouthfeel of a consumable comprising adding mouthfeel-improving amounts of at least one plant-derived non-beta-glucan carbohydrate fiber and at least one beta-glucan fiber to a consumable base.
33. Use of a combination of at least one plant-derived non-beta-glucan carbohydrate fiber and at least one beta-glucan fiber to improve the mouthfeel of a consumable.

As stated herein above, a particular aspect of the invention relates to a snack food composition that has incorporated therein a mouthfeel-improving additive. In snack food applications, the mouthfeel-improving additive contains beta-glucan fiber and preferably also contains at least one plant-derived non-beta-glucan carbohydrate fiber.

Another aspect of the invention relates to the use of the mouthfeel-improving additive as herein above described in a snack food.

In yet another aspect, the invention relates to a method of making a snack food, the method comprising the step of incorporating the mouthfeel-improving additive into a snack food dough and cooking the dough.

The term snack food as it is used herein refers to an item of processed food that is prepared by cooking a snack food dough. Typical snack foods include, but are not limited to baked foods, extruded snacks, cereals, tortilla chips, crisps, bars, pop corn, rice cakes, pastries, cakes, cookies, biscuits, savoury snacks, puffed snacks, crackers, multi-grains snacks, nachos, pork rind, prawn/fish crackers, pretzels, and the like.

A snack food dough can be prepared when moisture, for example water, is combined with a pre-mix of conventional ingredients, the specific identity and levels of which will vary depending to the type of snack food that is desired to be prepared. The ingredients of the pre-mix can be uniformly mixed before combining with moisture to form the dough, although some of the ingredients may be incorporated into the dough as a coating once the dough is formed. Indeed, in the method of incorporating the mouthfeel-improving additive into a dough to form a snack food, the additive can likewise be uniformly mixed with the other pre-mix ingredients, or coated onto the dough once formed.

A dough may incorporate one or more functional ingredients, either mixed uniformly within the body of the dough, or applied as a coating to the dough, to impart specific characteristics to the snack food. The dough may be formulated in such a way to improve its expansion characteristics, for example to achieve a higher expansion, providing a lighter texture to the consumer and/or a more consistent expansion. Other ingredients may be added to provide a flavour, or a colour or other visual effects, or a modification of texture, for example by providing a crunchy outer shell to an expanded snack food. As is known in the art, a dough may be formulated and processed to provide a desired moisture content, salt content, starch content, and the like.

A dough may be formed into any desirable regular, irregular or geometric shape before cooking, or it can even be formed into some representational shape such as a leaf, a fruit and vegetable, animal, or inanimate object before cooking. The dough may be shaped by mechanical action such as extrusion, pressing or moulding. Typically, the dough may be shaped into a string, a bead or a sheet before cooking.

The thickness of the shaped dough may vary, although a typical thickness would be at least 0.5 mm, typically from 0.5 to 4 mm, most typically from 0.6 to 0.8 mm.

Snack foods of the present invention are preferably provided in a consumer acceptable retail format, for example a packaging such as a bag or carton, typically hermetically sealed, which is compatible with a retail sales environment.

Typically, a snack food dough will contain two principle ingredients, namely a flour and water. The flour provides the essential structure and bulk of the dough; whereas water hydrates the dough and, in certain recipes containing gluten, will activate gluten to provide the dough with elasticity and structure modification.

Suitable flours include but are not limited to wheat flour, rice flour, corn flour, oat flour, barley flour, rye flour, spelt flour, buckwheat flour, millet flour, quinoa flour, semolina flour, almond flour, chickpea flour, potato flour, tapioca flour, lentil flour and pea flour.

In addition to the flour, other ingredients forming a pre-mix of a dough can be used in varying amounts depending upon the type of snack food that is desired to be prepared. Such ingredients include leavening/expanding/puffing agents that are employed to enhance the expansion of a dough, which can include waxy starches, baking powders or various carbonates (magnesium or calcium); sugar/salt can be added for taste; fats including solid fats, such as butter, lard, shortening or coconut oil, and liquid fats, such as canola, peanut, safflower, sunflower, or other vegetable oils; whereas flavours and colours can be employed to provide various and desirable hedonics and visual effects. Preservatives may be added to extend the shelf-life of the snack food.

In accordance with the invention, the mouthfeel-improving additive described herein above is incorporated into a pre-mix of a snack food dough, the dough is prepared by mixing moisture, e.g. water with the pre-mix ingredients, and the dough is cooked to form the snack food. The mouthfeel-improving additive may be incorporated in any suitable amount, which may vary depending upon the type of snack food desired to be prepared and the particular effect that is desired to be achieved.

In particular embodiments of the invention, the mouthfeel-improving additive is incorporated into a dough in a mouthfeel-improving amount. This amount may vary according to the type of snack food that is desired to be prepared, and the particular effects that are desired to be achieved. However, a typical level of incorporation of the mouthfeel-improving additive may be about 10 to 50 wt. % and more preferably 20 to 25 wt. % based on the weight of the pre-mix ingredients prior to the addition of water to form a dough.

In embodiments of the invention, the mouthfeel-improving additive comprising a beta glucan fibre and a non-beta-glucan carbohydrate fiber may be incorporated into a snack food by means of the simultaneous, separate or sequential addition of the beta glucan fibre and a non-beta-glucan carbohydrate fiber to the other ingredients of the pre-mix. In more particular embodiments, however, a mouthfeel-improving additive consisting of a combination of both a beta glucan fibre and a non-beta-glucan carbohydrate fiber is first prepared before the combination is added to the other pre-mix ingredients.

As stated herein above, the mouthfeel-improving additive contains a beta glucan fibre, and any of the non-beta-glucan carbohydrate fibers referred to herein above may also be combined with the beta glucan fiber in the additive.

In particular embodiments, the beta glucan fibre is an oat-derived beta glucan fibre. More particularly, the oat-derived beta glucan fibre is derived from oat kernels, and more particularly still is derived from the aleurone and sub-aleurone layers of the bran.

In more particular embodiments, the beta glucans in the beta glucan fibre have a molecular weight (Mw) in the range of about 1500 to 3500 kDa.

The molecular weight (Mw) of the beta glucans can be measured using Liquid Chromatography based on Size Exclusion (LC/SEC) and detection can be performed by conventional techniques, such as with Refractometer Detector (RID).

More particularly, molecular weight (Mw) of the beta glucan can be determined with an LC/SEC system using degassed, deionized water (with 0.1M NaNO3 and 5 mM NaN3 added to inhibit bacterial growth) as a mobile phase at 0.8 mL·min−1 flow rate. The eluent temperature and columns can be set at 40° C. Separation can be achieved over two columns PL Aquagel-OH mixed-H 8 μm particle size and 7.5×250 mm diameter/length and guard column of the same phase, purchased from Agilent Technologies (Santa Clara, CA).

Detection can be performed with a multi-detector system consisting of light scattering, refractometer, and viscometer from Agilent Technologies (part number #G7800A). Test samples can be weighed precisely and extracted with the mobile phase (0.1M NaNO3 and 5 mM NaN3) at 90° C. for 2 h30 under constant slow mixing. The same protocol can be applied to a beta-glucan standard. After cooling to room temperature, test samples, and beta-glucan standards can be filtered through a 0.10 μm filter (polyether sulfone membrane). The solutions obtained are then ready for use in LC/SEC analysis. The system can be calibrated with the beta-glucan a molecular weight standards kit from Megazyme (part #P-MWBGS, Neogen Lansing, MI), ranging from 33-667 kDa. Data acquisition can be performed using Agilent GPC/SEC software 2.2 dedicated to GPC calculations (part #G7850AA).

In particular embodiments of the invention, a preferred type of beta glucan fibre is one that in aqueous suspension exhibits a high viscosity in steady flow conditions at elevated temperature. More particularly, a preferred beta glucan fibre is one that in a 5% w/w dispersion in water exhibits a zero shear viscosity exceeding 10000 mPas at a temperature of 85 degrees centigrade, and a shear thinning behaviour in steady flow that can be described with a power law model with a K index of 19838 mPasⁿ and n of 0.327 across a range of shear rates from 0.1 to 100 s⁻¹ in a logarithmic ramp measured in an Anton Paar rheometer, equipped with a 2.2 mm gap Couette geometry.

Without wishing to be bound by any particular theory, it is believed that types of beta glucan fibre that can exhibit relatively and high and stable viscosities at elevated temperature may be those fibres that contain, in addition to beta glucans, a certain amount of proteins. The beta glucans are able to self-aggregate and interact with the proteins to form stable microgels. The higher amount of protein present will promote the formation of these beta glucan-protein complexes thought to be responsible for increasing viscosity and preventing degradation of the beta glucans.

In particular embodiments of the invention, preferred beta glucan fibre comprises beta glucan in admixture with proteins, wherein the proteins are present in at least 10 wt. %, and more particularly at least 20 wt. % based on the total weight of the beta glucan fibre. More particularly still, the preferred beta glucan fibre is an oat beta glucan comprising about 28 wt. % beta glucans and at least 20 wt. % of proteins. More particularly still, the preferred beta glucan fibre is an oat beta glucan fibre comprising about 50 wt. % dietary fibre, about 28 wt. % beta glucans, and about 23 wt. % proteins, obtainable from Givaudan under the SWEOAT™ brand.

The use of such beta glucan fibre in mouthfeel-improving additives according to the invention help to preserve the structure of snack food dough during extrusion (during which, extrusion process temperatures can reach 85° C. or higher), which in turn contributes to a finished snack food having a desirable light and crunchy texture.

In particular embodiments, the non-beta-glucan carbohydrate fiber is a type 2 high resistant starch, more particularly derived from banana, and more particularly still green banana powder.

In particular embodiments of the invention, the mouthfeel-improving additive may contain a beta glucan fibre and a plant-derived non-beta-glucan carbohydrate fiber in a weight ratio of 100:0.

In other particular embodiments the weight ratio of the beta glucan fibre to the plant-derived non-beta-glucan carbohydrate fiber falls within the range of 100:0 to 50:50, and more particularly 90:10 to 50:50, wherein every included range falling within these disclosed ranges is likewise intended to be specifically disclosed herein.

In particular embodiments of the invention, a snack food dough suitable to form extruded products or cereals includes a flour, such as corn flour, in an amount of about 75 to 80 wt. %; a mouthfeel-improving additive as defined herein in an amount of about to 25 wt. %; and other optional ingredients such as those referred to above in a range of 0 to about 5 wt. %, based on the total solids content of the dough.

In particular embodiments of the invention, a snack food dough for baked crisps, reconstituted chips and tortillas includes dehydrated potato flakes or masa flour each in an amount up to 45 wt. %; a mouthfeel-improving additive as defined herein in an amount of 20 to 25 wt. %; and other optional ingredients such as those referred to above in a range of 0 to about 5 wt. %, based on the total solids content of the dough.

In particular embodiments of the invention, a snack food dough particularly suitable for crackers, includes a flour in the range of about 40-80 wt. %; mouthfeel-improving additive in the range of 20 to 25 wt. %; and other optional ingredients such as those referred to above in a range of 0 to about 5 wt. %, based on the total solids content of the dough.

Forming a snack food generally involves combining ingredients in a pre-mix, adding moisture to form a dough, followed by moisture removal from the dough during cooking, e.g. by baking, frying or through a process of high-pressure extrusion, or a combination of these processes. Although the skilled person will appreciate that if a high-pressure extruder is employed in the preparation of the snack food, some moisture removal will occur contemporaneously with the extrusion process, and moisture can be further reduced with additional cooking steps, such as baking or frying. The ingredients may be mixed in any order, although mixing dry ingredients can be carried out first to evenly combine these ingredients prior to adding moisture such as water or fats or any other ingredients having a high moisture content to form a dough.

The ingredients can be mixed until a uniform mass of dough is obtained, with care to avoid overmixing, which is characterized by increased stickiness that can in turn make processing more difficult. The dough can then be formed for cooking, such as by sheeting and cutting, extruding, moulding, or any other desired method of forming that is conventional in snack food production.

Once formed, the dough is ready for cooking. During the cooking process the moisture in the dough forms steam which causes it to expand to form a cellular structure, to some extent, which is rigid. Without intending to be bound by any particular theory, the applicant believes that the mouthfeel-improving additive assists in the formation and preservation of an optimal cellular structure. The physical/mechanical properties of the snack food, relate to something meaningful and relevant to what consumers experience when they taste, chew and swallow a product, and can feed into the perception of improved mouthfeel. For example, the formation of pores can create a light and crisp texture. However, if the pore size is too large, it can affect the mechanical strength of the snack food, rendering it soft and less crisp or crunchy in the mouth. Large pore size can also increase salivary absorption, which in turn can leave the consumer with a dry mouth and unpleasant mouthfeel. The textural analysis of a snack food according to the present invention is set out in more detail in the examples, below.

### EXAMPLES

### Example 1—Orange Peach Mango Smoothie Powder Mix

An orange peach mango flavored dry powder smoothie mix was prepared with the following ingredients:

| Ingredient | gram/serving | % w/w powder | % w/w RTD |
|---|---|---|---|
| Fermented Protein | 12.500 | 46.296 | 4.764 |
| Pea Fiber | 1.420 | 5.259 | 0.538 |
| Beta-Glucan Fiber | 5.320 | 19.704 | 2.015 |
| Fat | 1.000 | 3.704 | 0.379 |
| Sweetener | 4.509 | 16.700 | 1.708 |
| Flavor | 1.783 | 6.604 | 0.675 |
| Masker | 0.258 | 0.956 | 0.098 |
| Probiotic | 0.067 | 0.248 | 0.025 |
| Vitamin C | 0.118 | 0.437 | 0.045 |
| Color | 0.025 | 0.093 | 0.009 |
| Sub-Total | 27.000 | 100.00 | 10.227 |
| Water | 237.00 | — | 89.773 |
| Total | 264.000 | 100.00 | 100.00 |

The ratio of the pea-derived non-beta-glucan carbohydrate fiber to the beta-glucan fiber is about 50:50 and can be calculated according to the following table:

| | | Beta | Beta | Total | | Non-beta |
|---|---|---|---|---|---|---|
| Ingre- | Ingredient | Glucan | glucan | Fiber | Fiber | Glucan |
| dient | (g/serving) | % | (g/serving) | % | (g/serving) | (g/serving) |
| Beta | 5.32 | 29.00 | 1.54 | 36.00 | 1.92 | 0.36 |
| Glucan | | | | | | |
| fiber | | | | | | |
| Pea | 1.42 | 0.00 | 0.00 | 83.50 | 1.19 | 1.19 |
| Protein | | | | | | |
| Fiber | | | | | | |
| Total | 6.74 | — | 1.54 | — | 3.10 | 1.55 |

### Example 2—Snack Food Application

### Preparation of Snack Foods:

“Sample 1” comprises corn grits (78 wt. %); and a mouthfeel additive consisting of an oat powder containing oat beta glucans (19 wt. %); and a green banana powder (3 et %).

“Sample 2” comprises corn grits (77 wt. %) and a texturizing agent consisting of type 3 resistant starch (Novalose 330 from Ingredion).

“Sample 3” comprises corn grits (81 wt. %) and a mouthfeel additive consisting of an oat powder comprising oat beta glucans (19 wt. %)

“Sample 4” comprises corn grits (78 wt. %) and a mouthfeel additive consisting of an oat powder containing oat beta glucans (22 wt. %)

Snack foods were prepared according to each of the aforementioned recipes by careful blending of the ingredients to form a dry mixture, which was then fed into a twin screw lab extruder (Clextral BC21). To achieve the desired results, specific temperatures were set for the extrusion barrels. The temperature profile was set as follows: Barrel 1: 25° C.; Barrel 2: 65° C.; Barrel 3: 95° C.; Barrel 4: 120° C.; Barrel 5: 135° C.; and Barrel 6: 155° C.

During the extrusion process, a water supply of 0.9 L/h was fed into the mixture to form a dough, such that a moisture level of 15% was maintained throughout the extrusion process. After extrusion, the moisture content of the product was further adjusted to a range of 6-8%. The dry mixture feeding rate is set at 11 Kg/h, to ensure a consistent and controlled flow of materials into the extruder. Regarding process parameters, a pressure range of 40-70 bar was held. The screw speed was set at 450 RPM, and the cutter speed at 250 RPM. A single die hole was used. The dimensions of the die hole were 3.5 mm in diameter and 4.5 mm in depth. Two blades were used in the setup positioned at a distance of 1 mm from the die, ensuring efficient cutting of the extruded product. The L/D ratio, which refers to the length-to-diameter ratio of the extruder screw, was 24. The water feeder is positioned at an L/D inlet position of 5 relative to the die to ensure desired moisture distribution and control throughout the extrusion process.

### Texture Analysis—Mechanical Testing

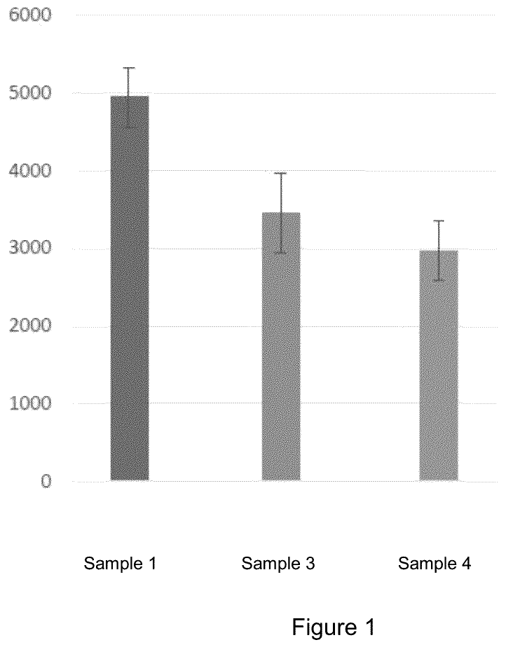

Mechanical testing was performed on a texture analyzer (TA.XT+C, Stable Micro Systems). Texture profile analysis was performed with a 20 mm diameter probe. The probe was lowered towards the sample at a rate of 1 mm/s, and when a trigger force of 5 g was encountered, the rate was increased to 5 mm/s, until a strain of 75% was achieved. The hardness of each sample was defined as the maximum force reached during the compression. The results are shown in FIG. 1.

### Texture Analysis—X-ray Tomography

X-ray micro-tomography was carried out on Samples 1 (illustrative) and 3 (Comparative). 3D images were acquired by X-ray micro-tomography using a rapid tomography device on the Tomcat beamline at the Swiss Light Source (SLS) Synchrotron located at the Paul Scherer Institute (PSI). All observations were carried out in absorption mode. A high speed camera was used allowing a field of view (FOV) of 15 mm×15 mm×4 mm, meaning about 9 cm³ for each scan, with an effective voxel size of 6.5 μm. For each sample, 13 vertical scans were performed. Only one repetition was made per sample.

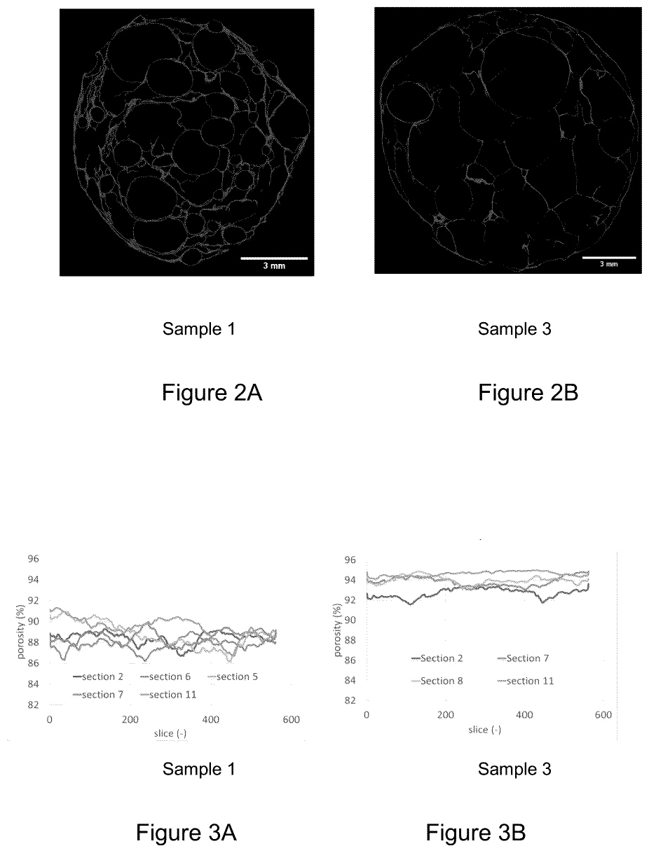

Definition of the Region Of Interest (ROI), segmentation and quantitative analysis was carried out in the following way: Following the acquisition, radiographic images were reconstructed into 3D images using appropriate algorithms. Following this step, the ROI of each image was defined. Voxels belonging to the air cells and cell walls of the Samples have to be retrieved from the image by distinguishing them from the voxels of the background. Because of the presence of ring artefacts, manual adjustments were made after visualization. Once the ROI was properly defined, an automatic threshold was applied in order to separate the cell walls from the air cells. Finally, from the segmented images, the porosity, defined as the ratio of air cell volume to total volume, was calculated. Also, the distributions of air cell and cell wall sizes were obtained using appropriate algorithms. For air cells and cell walls, the quartile and median diameters (D25, D50, D75) were extracted from these distributions and used to characterize the cellular structure of each of the Samples. FIG. 2 shows x-ray images of each sample displaying its internal cell structure. FIG. 3 is a graphical representation of the degree of porosity at across different sections of each Sample.

### Results and Discussion

FIG. 1 shows the measured hardness of each Sample. Sample 1 had the greatest hardness. Sample 2 and Sample 4 exhibited rather similar hardness, but both were of significantly lower hardness compared to Sample 1. It is generally accepted that the hardness measured in mechanical testing under compression is correlated positively with crispiness/crunchiness of a food product, including snack food.

Sample 4, illustrative of a composition containing a mouthfeel-improving additive containing solely an oat beta glucan fiber performed rather similarly to Sample 2, which is a commercial reference. Sample 1 significantly out-performed both the commercial reference and the Sample 4, which nevertheless both had acceptable mouthfeel performance.

FIG. 2 illustrates the internal structural differences between Sample 1 and Sample 3. Sample 3 appears to have reached a higher level of expansion during the extrusion process compared to Sample 1, which accounts for the differences in hardness between the two samples. Indeed, the more air incorporated in any cellular solid, the softer its mechanical properties tend to be.

FIG. 3 illustrates the degree of porosity derived from several 3D sections (each of them composed by ≈500 2D cross sections) of the Samples acquired by x-ray tomography. For each section tested Sample 3 had a significantly higher porosity than Sample 1. The average porosity (averaging all of the sections tested) was 93.8±0.8 for Sample 1 vs 88.5±0.6 for Sample 3

Regarding the average cell wall thickness, no significant difference was observed between Samples 1 and 3 on D25 and D50. On the other hand, significant differences were found on D75. Indeed, for Sample 1, 25% percent of the cell walls were thicker than 0.065±0.006 while for Sample 3, this value was significantly lower (0.046±0.046). This means that differences in the cell wall thickness between the two samples are found only on the largest 25% of the cell walls, which are thicker for Sample 1 than for Sample 3. In cellular solids, thicker cell walls are generally stiffer and are characterized by a higher fracture force, which in a snack food can be in turn associated with an increased crispiness/crunchiness, which is highly desirable.

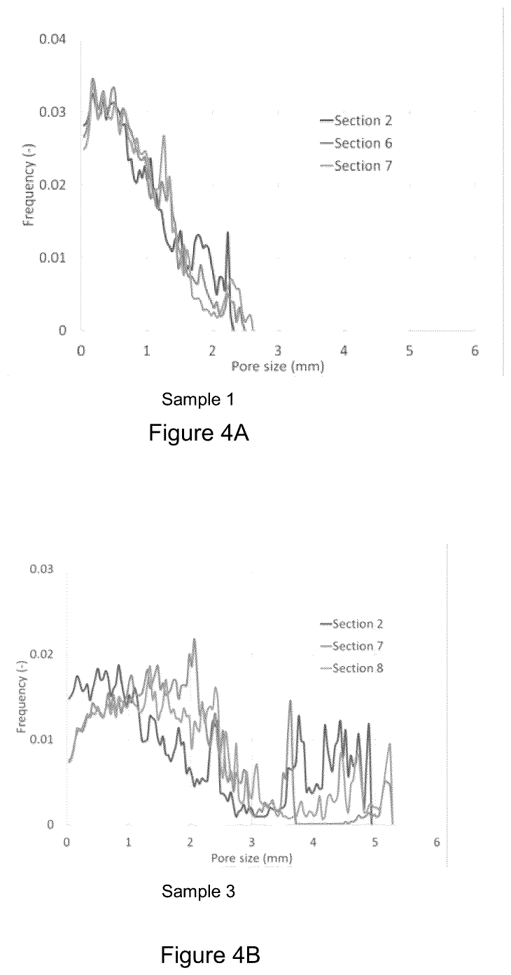

FIG. 4 illustrates pore size distribution of different 3D cross sections for Sample 1 (left) and Sample 3 (right). Regarding the pore size, Sample 1 had a narrower distribution than Sample 3. It was therefore confirmed that Sample 3 had not only a higher porosity, but also a larger pore size than Sample 1. It is generally recognized that a high porosity and large pore sizes in snack foods, such as extruded snacks, display faster water absorption kinetics that could promote salivary absorption and trigger an undesirable dry mouthfeel.

It should be understood that when a range of values is described in the present disclosure, it is intended that any and every value within the range, including the end points, is to be considered as having been disclosed. For example, “a range of from 50 to 100” of a component is to be read as indicating each and every possible number along the continuum between 50 and 100. It is to be understood that the inventors appreciate and understand that any and all values within the range are to be considered to have been specified, and that the inventors have possession of the entire range and all the values within the range.

The compositional weight percentages disclosed herein are based on the total weight of the composition or consumable, as the situation dictates. It will be understood to one of ordinary skill in the art that the total weight percent of the compositions and consumable cannot exceed 100%. For example, a person of ordinary skill in the art would easily recognize and understand that a composition comprising xₐ to yₐ weight percent of a plant-derived non-beta-glucan carbohydrate fiber, x_{b} to y_{b} weight percent beta-glucan fiber, and xc to ye weight percent further additives will not exceed 100%. A person of ordinary skill in the art would understand that the amount of the components may be adjusted to include the desired amount of component without exceeding 100% by weight of the composition or consumable.

In the present disclosure, the term “about” used in connection with a value is inclusive of the stated value and has the meaning dictated by the context. For example, it includes at least the degree of error associated with the measurement of the particular value. One of ordinary skill in the art would understand the term “about” is used herein to mean that an amount of “about” of a recited value produces the desired degree of effectiveness in the compositions and/or methods of the present disclosure. One of ordinary skill in the art would further understand that the metes and bounds of “about” with respect to the value of a percentage, amount or quantity of any component in an embodiment can be determined by varying the value, determining the effectiveness of the compositions for each value, and determining the range of values that produce compositions with the desired degree of effectiveness in accordance with the present disclosure. The term “about” is further used to reflect the possibility that a composition may contain trace components of other materials that do not alter the effectiveness or safety of the composition.

As used in this specification, the terms “comprises,” “comprising,” “contains,” “containing,” “includes,” “including,” “has,” or “having,” are all open-ended expressions and are intended to cover apparatus, compositions, methods, processes, products, or systems that comprise a recited list of components, elements, and features, and any and all additional components, elements and features that are not expressly recited. The terms “includes,” “including,” “has,” or “having” are not intended to have a more narrow construction, interpretation, or meaning than the terms “comprises” or “comprising.”

As used in the present specification, the term “or” refers to an inclusive “or” and not to an exclusive “or”. For example, the phrase “A or B” is satisfied by any one of the following: A is present and B is not present, A is not present and B is present, and both A and B are present.

As used in the present specification, “a” or “an” is employed to describe components, elements, features and method/process steps of various illustrative embodiments disclosed herein. The use of “a” or “an” should be interpreted to include one or more than one.

As used in the present specification, any of the terms “illustratively,” “preferably,” “commonly,” and “typically” are not intended to, and do not, limit the scope of the claimed embodiments, or to imply that certain features are critical, essential, important, or required to the structure or function of the claimed composition, beverage product or methods. Rather, these terms are merely intended to identify particular aspects of an embodiment or to emphasize alternative or additional features that may or may not be utilized in a particular embodiment.

While the compositions, process for making for the compositions, process for using the compositions, and the consumables have been described above in connection with certain illustrative embodiments, it is to be understood that other embodiments may be used or modifications and additions may be made to the described embodiments for performing the same function of the present embodiments without deviating therefrom. Further, all embodiments disclosed are not necessarily in the alternative, as various embodiments of the invention may be combined to provide the desired characteristics. Variations can be made by one having ordinary skill in the art without departing from the spirit and scope of the disclosure. Therefore, the present disclosure should not be limited to any single embodiment, but rather construed in breadth and scope in accordance with the recitation of the attached claims.

1. A mouthfeel-improving additive for use in a snack food comprising at least one beta glucan fiber.

2. The mouthfeel-improving additive according to claim 1, wherein the at least one beta glucan fiber is an oat beta glucan fiber.

3. The mouthfeel-improving additive according to claim 2, wherein the oat beta glucan fiber has a molecular weight (Mw) in the range of 1500 to 3500 kDa.

4. The mouthfeel-improving additive according to claim 3, wherein the oat beta glucan fiber comprises at least 10 wt. % of proteins, based on the total weight of the oat beta glucan fiber.

5. The mouthfeel-improving additive according to claim 3, wherein the oat beta glucan fiber comprises at least 20 wt. % of proteins, based on the total weight of the oat beta glucan fiber.

6. The mouthfeel-improving additive according to claim 4, wherein the oat beta glucan fiber comprises about 28 wt. % beta glucans, based on the total weight of the oat beta glucan fiber.

7. The mouthfeel-improving additive according to claim 1 comprising at least one beta glucan fiber and at least one plant-derived non-beta glucan fiber.

8. The mouthfeel-improving additive according to claim 7, wherein the at least one plant-derived non-beta glucan fiber is derived from banana.

9. The mouthfeel-improving additive according to claim 8, wherein the at least one plant-derived non-beta glucan fiber is green banana powder.

10. The mouthfeel-improving additive according to claim 1, wherein the at least one beta glucan fiber exhibits a zero shear viscosity exceeding 10000 mPas at a temperature of 85 degrees centigrade in a 5% w/w dispersion in water.

11. The mouthfeel-improving additive according to claim 7, wherein the weight ratio of the beta glucan fibre to the plant-derived non-beta-glucan fiber falls within the range of 90:10 to 50:50.

12. A snack food comprising the mouthfeel-improving additive according to claim 1.

13. A snack food comprising the mouthfeel-improving additive according to claim 7.

14. The snack food according to claim 12, wherein the snack food is selected from the group consisting of baked foods, extruded snacks, cereals, tortilla chips, crisps, bars, pop corn, rice cakes, pastries, cakes, cookies, biscuits, savoury snacks, puffed snacks, crackers, multi-grains snacks, nachos, pork rind, prawn/fish crackers, pretzels, and combinations thereof.
